(19) United States
(12) Patent Application Publication
(10) Pub. No.: US 2022/0347556 A1
(43) Pub. Date: Nov. 3, 2022

(54) Searching Game System

(71) Applicant: YANG GUO, Lino Lake, MN (US)

(72) Inventor: YANG GUO, Lino Lake, MN (US)

(21) Appl. No.: 17/733,997

(22) Filed: Apr. 30, 2022

Related U.S. Application Data
(60) Provisional application No. 63/182,770, filed on May 1, 2021.

(51) Int. Cl. A63F 11/00; A63F 9/24; H04W 4/029; H04W 4/80; H04B 17/318

(52) U.S. Cl. CPC A63F 11/0074; A63F 9/24; H04W 4/029; H04W 4/80; H04B 17/318; A63F 2011/0079; A63F 2009/2489

(57) ABSTRACT

A searching games system comprised Bluetooth hidden object, mobile device and cloud server. Mobile device can locate the hidden object by Bluetooth low energy technology, plus GPS and algorithms. The location of hidden object is visualized on the mobile device. The hidden object information can also be shared through network to other players who want to join the searching game. In this manner, the game can be played in backyard, playground, in house or open area, e.g. park, like a championship.

### CROSS REFERENCE TO RELATED APPLICATIONS

This application claims the benefit of U.S. Provisional Patent Application No. 63/182,770, filed May. 1, 2022, which is incorporated by reference herein in its entirely.

REFERENCES CITED

| | | |
|---|---|---|
| 6,311,982 B1 | Nov. 6, 2001 | Steven et al. |
| 7,695,338 B2 | Apr. 13, 2010 | Dooley et al. |
| 8,157,610 B1 | Apr. 17, 2012 | Dietz et al. |
| 8,808,052 B2 | Aug. 19, 2014 | Yang et al. |
| 8,814,688 B2 | Aug. 26, 2014 | Jonathan et al. |
| 9,011,194 B2 | Apr. 21, 2015 | Colbert et al. |
| 9,138,650 B2 | Sep. 22, 2015 | Barney et al. |
| 9,320,976 B2 | Apr. 26, 2016 | Weston et al. |
| 9,616,334 B2 | Apr. 11, 2017 | Weston et al. |
| 9,814986 B2 | Nov. 14, 2017 | Judkins et al. |
| 10,058,775 B2 | Aug. 28, 2018 | Segal et al. |
| 10,163,361 B2 | Dec. 25, 2018 | Chen et al. |
| 10,188,939 B2 | Jan. 29, 2019 | Zhang et al. |
| 10,441,879 B2 | Oct. 15, 2019 | Panec et al. |
| 10,610,777 B2 | Apr. 7, 2020 | Doptis et al. |
| 10,369,487 B2 | Aug. 6, 2019 | Goslin, et al. |
| 2012/0009845 A1 | Jan. 12, 2012 | Richard et al. |
| 2004/0137929 A1 | Jul. 15, 2004 | Jones et al. |

### BACKGROUND/SUMMARY

### Background

Outdoor exercise with exploration is attractive to kids and adult. After hiding a hidden object with Bluetooth signal, player(s) can search for it by using mobile device. Benefit from latest mobile technology, Bluetooth low Energy, known as BLE, and GPS, the search process can be very challenging, customizable, organizable, and player can share the searching goal with other players thought network where more players can join and search together like a championship.

### Summery

An object of the present invention is to provide a system of searching object game by integrating programmable Bluetooth low energy module into hidden object, and using mobile device to facilitate searching for the hidden object. First, a hidden object with integrated BLE module, is placed in game area by a player. Then one or more other players try to find the hidden object(s) by using mobile device which can detect and locate hidden object.

Besides playing in limited area, e.g. playground, benefit from BLE and GPS technology, one player can place a hidden object in open area e.g. hiking trail, and share the searching goal with others through network. Then other player can join the search and share result.

More than one hidden object can be placed when playing the game, and winner can be ranked based on the game time, number of findings, value of findings, and so on.

Another object of the present invention is to integrate Bluetooth Low Energy, Known as BLE, in the hidden object. Since BLE module has long battery life, long signal distance, re-programmability, locating capability and two-way communication, the game system with BLE module in hidden object and mobile device provide a new form of entertainment and allow customizing game dynamically during the game time.

The system of the present invention comprises at least one hidden object integrated with BLE module and a mobile device. To be able to share searching goal and searching result cross multiple players, a server can be adopted in the system to exchange game information between players. In an embodiment, hidden object can imitate different kinds of real items, e.g. gold coin, to improve the playability.

### BRIEF DESCRIPTION OF THE DRAWS

Various objects and a more complete understanding of the present invention are apparent and more readily appreciated by referring to the following detailed description and to the appended claims when taken in conjunction with the accompanying drawings:

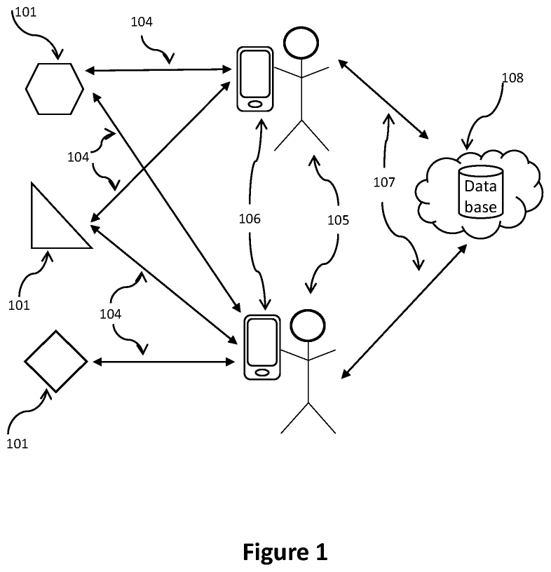

FIG. 1 is high level system diagram of searching object game to illuminate different parts of the searching game system. The diagram also includes communication between different parts in the game system.

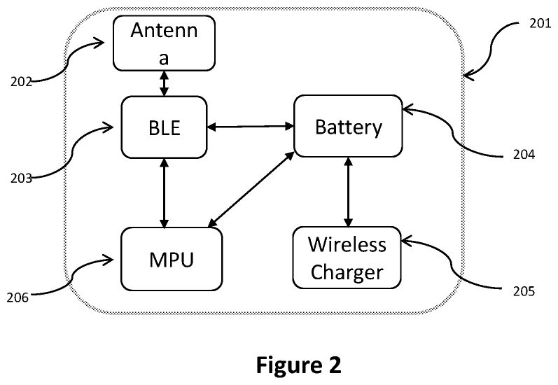

FIG. 2 is a diagram of a structure view of hidden object in where BLE module is integrated.

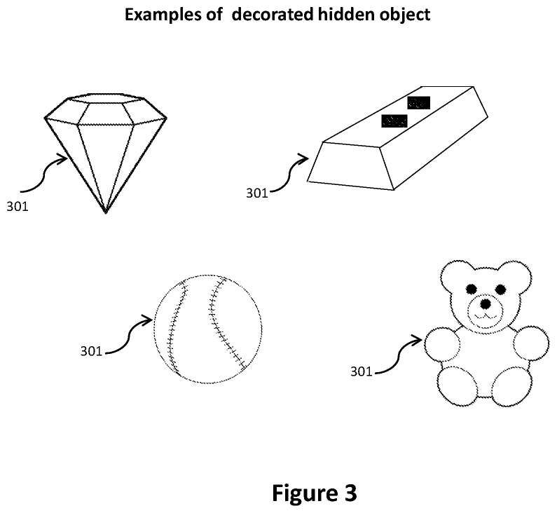

FIG. 3 illustrates some embodiments of decorated hidden object.

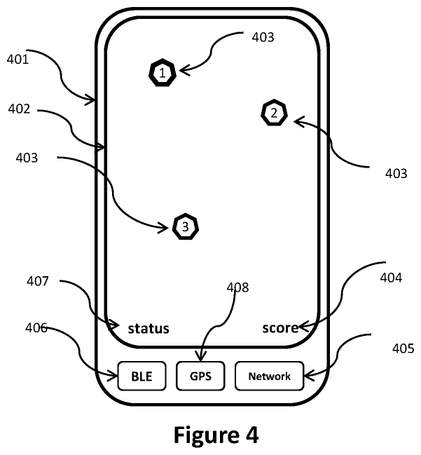

FIG. 4 is an embodiment of the mobile device with components and user interface of the present invention.

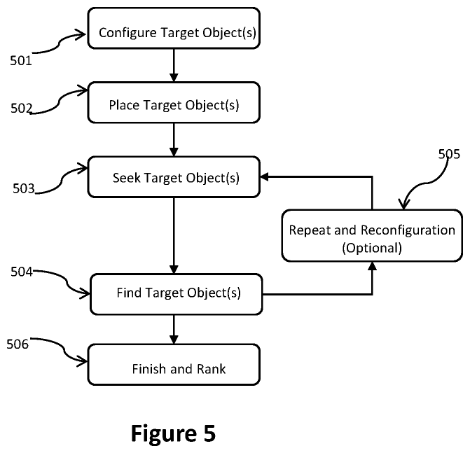

FIG. 5 is an embodiment of high level game process of the present invention.

### DETAIL DESCRIPTION

Several embodiments of the present invention are described below. It will be understood that the invention is not limited to these embodiments, but is only limited by the appended claims. While any mobile device may be used to implement the present invention, assuming it has sufficient computing power for data processing and to display animations on the screen, a phone is used in the preferred embodiment. It will be understood, however, that any mobile device, laptop, or gaming device with Bluetooth capability may also be used to implement the present invention. Wearable computing devices may also be used. For simplicity, the word “phone” is used in the below disclosure to describe the mobile device.

In its preferred embodiment, as shown in FIG. 1, in high level, searching object game system contains one or more hidden object 101. Each hidden object is integrated with Bluetooth chip and able to communicate with mobile device 106 through wireless Bluetooth communication protocol 104. Mobile device can detect and deduce the position of hidden object 101 based on the data received through BLE communication 104. Player(s) 105 uses mobile device 106 to help locate the hidden object. Graphic User Interface on mobile device 106 can visualize the location information to help searching. Multiple players 105 can compete in same searching target, namely hidden object 101, a server in cloud 108 is used to share searching target, broadcast status from individual player, and maintain the overall game status. Network 107 is used when mobile device communicates with server. Depend on the players' organization, server can be accessed through either internet or a local network.

Bluetooth Low Energy, known as BLE, provides several locating solutions. The most accurate BLE locating technology is Angle-Of-Arrival (AoA) and Angle-Of-Departure (AoD). The AoA and AoD uses antenna array to detect the angle of signal to calculate the position of a BLE source. The other BLE locating technology is Triangulation based on BLE signal strength from multiple BLE source. Benefit from computing power of mobile device and BLE module on hidden object, triangulation can be performed when more than one hidden objects 101 exist in play area. The other locating technology is GPS plus BLE, where mobile device gets GPS location, then deduces hidden object location based on the BLE signal strength and GPS locations collected when player is moving. Location can also be calculated based on RSSI (Received Signal Strength Indicator) in BLE communication which is a well-known solution for distance measurement.

Depending on the particular embodiment, a cloud database 108 is used to share and exchange game data cross different players. The cloud database can be hosted by any network device which provides data exchange capability to phones 106. The cloud database may also use an existing network communication application, e.g. Facebook and Instagram as long as the application allows data exchanged cross players.

Referring now to the drawing FIG. 2, is a high-level architecture view of an illustrative embodiment of a hidden object. In FIG. 2, all electric elements in a hidden object is encapsulated and sealed in a shell 201. After sealing, hidden object can be water proof and be placed in play area without worrying about moisture. BLE module 203 can run in low power operation mode which allow it run for month with single AA battery. This gives long game time after deploying a hidden object in play area. This is a meaningful solution when playing in an open area, e.g. hiking trail. BLE module 203 emits signals through antenna 202 to reveal itself to mobile device. BLE module 203 can have multiple different signaling schema to adapt different game mode and difficulties. As an example, BLE signal strength can be dynamically changed to provide different game difficulty, and turn off at night. In another example, BLE signal may include the score of a hidden object. If a hidden object cannot be found in a period, score is increased periodically. The MPU 206 controller the BLE signal schema and game logic.

To use battery 204 power efficiently, BLE signal strength can be configured according to play area. Benefit from BLE technology, a BLE module can be detected from miles away which give broad play area. BLE technology also provides reprogramming capability which allows to dynamically change game rules to add more variability. Reprogramming is performed by mobile device 106 in FIG. 1. As an example, if players want to finish the game quickly, mobile device 106 in FIG. 1 may program hidden object 101 in FIG. 1 to emit stronger signal with longer duration, so a hidden object gives more accurate positioning information and is easier to be found. Reprogramming can also set BLE module in a low power mode if no game is running, known as out of game session, to avoid waste power. After hidden object runs out of battery, battery 204 can be charged wirelessly thought wireless charger module 205. Wireless charging avoid opening in shell which enhances water-proof capability.

Referring now to the drawing FIG. 3, depending on the particular embodiment, hidden object can be made to imitate real world object, e.g. diamond 301, baseball 301, golden bar 301, stuffed animal 301. The appearance of a hidden object will not change the function of a hidden object, the internal design of hidden object keeps same as illustrated in FIG. 2. The appearance of hidden object can be changed variously to meet different scenario and player group, e.g. cute animal appearance is preferred by kids.

In an embodiment shown in FIG. 4, a mobile device 401 display game data to player on mobile screen 402. Mobile device 401 receives Bluetooth signal and from hidden object through BLE module 406 which is built into mobile device. Mobile device can calculate the hidden object location by using the received Bluetooth signal. Here the Bluetooth signal carries data based on customized BLE communication protocol. As an example, the Bluetooth signal contains time-stamped data of Angle-Of-Arrival (AoA) and Angle-Of-Departure (AoD). To allow real-time location calculation, the BLE communication protocol is able to reflect real-time relationship between hidden object and mobile device. Besides BLE, location from GPS module 408 in the phone is also utilized to calculate the hidden object location. To refine location of a hidden object, mobile device can recalculate the location based on historical GPS and BLE data and new incoming data. Historical GPS and BLE data may be stored on mobile device to allow recalculation.

Hidden object location is visualized and displayed on the mobile screen 402 in FIG. 4. Since each physical hidden object 101 in FIG. 1 has unique identifier, it can be presented as virtual hidden object 403 on screen 402, and can be presented differently from each other on screen 402. Other game information are also displayed on the screen 402 to enhance the interaction and entertainment. For example, current score 404 and game status 407 are presented to give player real-time status. As an embodiment, the score 404 can base on the count of hidden object(s) found by a player, and individual score of each hidden object which can be different from each other. Game status 407 can base on the local data on current mobile device 401 and/or data from server received by network module 405. As an example, the game status can tell how many players are searching for same hidden object; highest score in current game session; time left for current game session. Mobile device uses vibration, sound, and screen information to inform player about the approaching. As an example, quick flash symbol on mobile screen 402 can be shown when player is approaching closely to a hidden object, and vibration can be triggered when hidden object is found. Benefit from mobile network 405, a player can announce search objective by broadcast information in network, e.g. hidden object ID, to other players. Then other players can join the search and share the result through network.

FIG. 5 illustrates an embodiment of a search game flow. The illustrated game flow follows the direction of arrow in FIG. 5. Block 501 initiates a new game session by configuring hidden object, install mobile application, announce searching goal verbally or through network, players joining searching group if need, and setup game criteria e.g. duration. The next step, Block 502, is to place hidden object(s) for searching. Block 503 is main game activity where player(s) searches for hidden object(s) with the help of mobile device. Player status can be shared through network dynamically during game session. After a hidden object is found 504, player can switch to search next hidden object, and discovered hidden object can be deactivated and invisible in current game session by BLE reprogramming. When searching for next hidden object, based on game circumstance, other hidden object can be reprogrammed by mobile device silently without player intervention. Such automatic hidden programming adds variety and unpredictability which gives more challenge, for example, increasing the score of undiscovered hidden object. After game ending criteria is met, e.g. game time reached, block 506 is entered as the end of game session where final scores are ranked for all players and winner is announced, player may collect all hidden objects back and power them off by reprogramming.

What is claimed are:

1. A searching game system comprising:
Hidden object integrated with Configurable Bluetooth module to communicate with mobile device in play area. The configurable Bluetooth module in hidden object to allow changing game rule dynamically.
Mobile device with Bluetooth module and/or GPS module to communicate with hidden object in play area. Mobile device can configure game rules.
A server can be used to share and collect the searching game data between mobile devices through network. The server can also distribute the searching game configuration to mobile devices.

2. The searching game system of claim 1, wherein one or more Bluetooth integrated hidden objects are placed in play area when playing the game. Bluetooth module in hidden object broadcasts Angle-Of-Arrival (AoA) or Angle-Of-Departure (AoD) data, RSSI data (Received Signal Strength Indicator), time stamp, unique identifier, and other metadata to mobile device. Each hidden object can emit signal based on its configuration.

3. The searching game system of claim 1, wherein mobile device receives Bluetooth data from hidden object and/or receives GPS data to calculate the location of a hidden object. If GPS is turned off on mobile device, the game application on mobile device can still calculate the hidden object location based on Bluetooth signal and historical data stored on the mobile device. The location of hidden object can be visualized on application graphic user interface. Multiple mobile devices can run the game application at the same time to search single hidden object or a hidden object set, so multiple players can run the game at the same time as a champion mode.

4. The searching game system of claim 1, wherein mobile device sends game data to cloud server to share game data and status with other players. Other player can join the searching game any time after getting the target hidden object data. A players can share the target hidden object data with others as well as messaging with each other players through the game application on the mobile device.

5. The searching game system of claim 1, allows multiple players play game together by searching same or different hidden object. The final score can be ranked based on the searching result from each player, and shared between players through server.

6. The searching game system of claim 1, allow player to change Bluetooth module setting in hidden object by reprogramming through Bluetooth communication. The MPU module in hidden object can store different configurations and operate as different configuration. From different configurations, hidden object can be renamed, the visibility of a hidden object can be tuned by changing Bluetooth signal strength, Bluetooth signal interval, and data carried by Bluetooth signal. On mobile device, the searching game application can configure a hidden object through user interface. The searching game application can store and operate as different configurations. Configuration can include, but not limited to, minimizing the power consumption on hidden object based on the size of play area or the duration of game session; setting difficulty of the game; setting game rule based on players' negotiation; setting maximum players in a game session; setting the length of game session; setting how to rank the final score. When no active game session, Bluetooth module can run in sleep mode to save power.

7. The searching game system of claim 1, can activate Bluetooth module in hidden object based on game configuration. As example, but not limited to, one game configurations can be that only one hidden object is activated and visible by broadcasting Bluetooth signal at beginning of a game session. After the first hidden object is found, next hidden object is activated in order. Another game configuration can be to activate hidden object with a defined interval. Game can also be configured to activate all hidden objects together.

8. Method in searching game system comprising:
Location calculation, which is one of key feature of the game system, several different locating methods are used together or separately to get best location result. Location calculation can be any combination of Bluetooth Angle-Of-Arrival (AoA) and Angle-Of-Departure (AoD), triangulation from wireless signal strength indicator, and historical data, GPS data.
Configuration, transferred between hidden object and mobile device through Bluetooth communication; changed by game application from network and graphic user interface. Both hidden object and game application on mobile device can store and operate with different configuration. Wherein game rule is changable by configuration data.
Real time status update on mobile device, is presented through mobile device graphic user interface, sound, vibration; the real time status is also broadcasted through BLE and Network to other mobile device which runs in a game session. The real-time status including, but not limited to, the location of hidden object, progress of a game session, and timely messages from other players.
